(19) United States
(12) Patent Application Publication
(10) Pub. No.: US 2018/0068338 A1
(43) Pub. Date: Mar. 8, 2018

(54) METHOD AND SYSTEM FOR INCENTIVIZING USERS TO MAKE PURCHASES

(71) Applicant: Google Inc., Mountain View, CA (US)

(72) Inventors: Justin Lewis, Marina del Rey, CA (US); Ruxandra Georgiana Paun, Santa Monica, CA (US)

(73) Assignee: Google Inc., Mountain View, CA (US)

(21) Appl. No.: 14/183,358

(22) Filed: Feb. 18, 2014

(51) Int. Cl. G06Q 30/02

(52) U.S. Cl. CPC G06Q 30/0235

(57) ABSTRACT

In a method and system for incentivizing a user to make a purchase, social relationship data for a user of an online social network is identified, and an offer is provided to the user to purchase an item at a promotional price if an acceptance of the offer by the user satisfies a timing condition with respect to the other users purchasing the item. In response to receiving an acceptance of the offer, whether the acceptance of the offer by the user satisfies the timing condition with respect to the other users purchasing the item is determined. In response to determining that the acceptance of the offer by the user satisfies a timing condition with respect to the other users purchasing the item, an indication that the user is allowed to purchase the item for the promotional price can be provided.

### TECHNICAL FIELD

Aspects of the present disclosure relate to the field of Internet sales and, more particularly, to a method for incentivizing users to make purchases.

### BACKGROUND

Limited-time promotions and offers can be one way of incentivizing people to make purchases, because there is a limited period of time in which to make a purchasing decision. Internet retail websites that offer flash sales, which offer limited quantities of items at a promotional price for a limited time, can be popular with user. Aspects of this popularity could be attributable to the desire of consumers to take advantage of what they consider to be good deals.

Furthermore, on the Internet, social networking services or other applications allows a user to be associated with other users. These associated users may assert an influence over each other's purchases (e.g., retail or online purchases). In other words, if one of the associated users purchases an item, others users that become aware of this purchase may also be inclined to purchase the same item.

### SUMMARY

In some implementations, a method to incentivize users to make purchases is presented. The method includes identifying social relationship data for a user of an online social network, the social relationship data indicating other users associated with the user in the online social network, and providing an offer to the user to purchase an item at a promotional price if an acceptance of the offer by the user satisfies a timing condition with respect to the other users purchasing the item. The method also includes receiving an acceptance of the offer from the user, and, in response to receiving the acceptance, determining whether the acceptance of the offer by the user satisfies the timing condition with respect to the other users purchasing the item. In response to determining that the acceptance of the offer by the user satisfies a timing condition with respect to the other users purchasing the item, an indication that the user is allowed to purchase the item for the promotional price can be provided.

In some implementations, a code for the user to share with the other users can be provided, where the code allows each of the other users to purchase the item at a discounted price. The code may be only valid for a time period.

In some implementations, the promotional price can be based on a number of the other users associated with the user in the online social network. The offer may be valid for a promotional period, and the indication that the user is allowed to purchase the item for the promotional price may be further in response to determining that the user accepted the offer within the promotional period.

In some implementations, the method may further include allowing any of the other users to purchase the item at the promotional price for a period after the user accepts the offer. Providing the indication that the user is allowed to purchase the item for the promotional price can include determining that the user has notified the other users that the user has accepted the offer. In an implementation, the timing condition can be satisfied if the user accepts the offer prior to any other user associated with the user in the online social network, or the timing condition can be satisfied if the user accepts the offer within a predefined time period from a purchase of the item by one of the other users associated with the user in the online social network.

In another implementation, a method for incentivizing a user to make a purchase includes receiving a request from a user for a price of an item, the request including a user ID of the user and an item ID for the item, and identifying a social graph for the user based on the user ID, wherein the social relationship data includes a set of other users associated with the user on an online social network. The method also includes identifying a number of other users in the social relationship data that have purchased the item, and identifying a timestamp for each purchase. The method further includes identifying an earliest purchase time based on the timestamp of each purchase, identifying a promotional price determined based on the time of the request, the earliest purchase time, and a purchase criterion, and providing the promotional price to the user.

In some implementations, the method further includes identifying a purchase period calculated based on the time of the request, the earliest purchase time, and the purchase criterion, and providing the purchase period to the user.

### BRIEF DESCRIPTION OF THE DRAWINGS

The present disclosure will be understood more fully from the detailed description given below and from the accompanying drawings of various embodiments of the disclosure.

FIG. 1 illustrates exemplary system architecture, in accordance with one embodiment of the present disclosure.

FIG. 2 illustrates an offer sub-system, in accordance with one embodiment of the present disclosure.

FIG. 3 is a flow diagram illustrating one embodiment for a method of incentivizing users to make purchases.

FIG. 4 is a flow diagram illustrating one embodiment for another method of incentivizing users to make purchases.

FIG. 5 is a block diagram of an exemplary computer system that may perform one or more of the operations described herein.

### DETAILED DESCRIPTION

Aspects of the disclosure pertain to a method of incentivizing users via a third party platform (e.g., an online social network) to make purchases. In some implementations, a user's social relationship data can be determined (e.g., a social graph determining other users associated with the user on an online social network), and a promotional price for an item, such as online content (e.g., video content, audio content, computer games, electronic books, applications, etc.), services (e.g., memberships, monitoring, etc.), or physical items (e.g., books, toys, games, collectibles, etc.), can be offered to the user, where the user can only purchase the item for the promotional price if the user satisfies a timing condition. For example, the timing condition can be that the user should purchase the item before anyone else in the user's social graph, or that the user purchases the item within a certain time period after a first purchase of the item by an associated user. This timing condition can motivate the user to quickly take advantage of what the user perceives to be a good deal

For example, if a new season of a popular television show known as Show A has just been released, a content provider can offer a User A a promotional price that would allow User A to purchase the new season of Show A from the content provider for a certain discount if User A is the first to buy the new season of Show A out of all of the users associated with User A (e.g., “friends” of User A) on an online social network.

Further, having a promotion for an item introduced through a social setting, e.g., coming from a friend, may make the promotion more effective, since the promotion may be perceived as being a recommendation from the friend. The promotion can be make even further more effective if the friend includes some sort of annotation that endorses or approves of the item.

For example, User A can be allowed to indicate (e.g., post on the user's account on the online social network) that User A was the first to purchase the new season of Show A and/or provide the other users with a code that will permit the other users to purchase the new season of Show A at a promotional price, e.g., within a certain period of time, such as 24 hours.

In an example, User A might receive a notification (e.g., an email or message through the online social network) about the promotional price, e.g., based on User A's previous purchase of an earlier season of Show A or a similar or related show. From the notification, User A knows that User A can only purchase the item for the promotional price if User A is the first to purchase the new season of Show A from among the associated users. The promotional price and the limited time to act can convince User A to purchase the new season of Show A immediately.

In an example, User A can receive a confirmation (e.g., via an email) that allows User A to post (e.g., on the online social network) about the purchase and allow associated users to also purchase the new season of Show A at a promotional or discount price. For example, User A may receive a code that User A can send (e.g., via email or text) or post via the online social network for the associated users to view. However, in an example, the offer to the associated users may only be valid for a limited time (e.g., 24 hours) from the time of User A's purchase.

Further to this example, User B may become aware of the code (e.g., by viewing the post of User A) even though User B has not purchased previous seasons of Show A, and may decide to purchase the new season of Show A before the offer expires. Because User B knows that User A and possible other associated users will be viewing the new season of Show A, User B makes the purchase because User B wants to be able to discuss the new season of Show A with the associated users and does not want learn about it (i.e., find spoilers) before getting an opportunity to view it. Further, being able to purchase at the promotional price is appealing to User B because User B may perceive the promotional price as being a good deal. User B may also respect User A's opinions and want to make the purchase because User A made the purchase.

In some implementations, because users like getting discounts, like being able to be perceived as being the first to purchase something (i.e., as an early adopter), and like being able to provide a discount to their friends, users may view this type of promotion as being beneficial. Furthermore, the content provider can view this type of promotion as being beneficial because more users purchase content. The online social network can view this type of promotion as beneficial because the promotion can be the source of additional posts.

In an implementation, social relationship data (e.g., a social graph) can be utilized to identify associated users (e.g., “friends”) on an online social network. The social networking data can include a set of unique user identifiers and edges between those users. The social networking data can include one way or two way edges. In an embodiment, either edge direction could be counted as a “friend”. An advantage of only counting outgoing edges is that the purchasing user feels like they are in control. An advantage of counting incoming edges is that the purchasing user is not able to easily disassociate from (or “unfriend”) a user to be able to get a discount.

For example, a user might try to unfriend another user who has already purchased an item where a promotional price has been offered as described above. However, the set of associated users that a user has could be recorded when the promotional price is initially offered. Here, removing an associated user that has already purchased the item will not then make the user eligible for the promotional price because the set of associated users used for the determination of who is the first purchaser has already been recorded.

In an implementation, a price for an item can be derived from a user's social relationship data. For example, a greater discount can be offered to a user with a larger number of associated users. In one example, a user with more than one thousand friends might receive a promotional price that is a 50% discount, while a user with only 100 associated users might receive only a 25% discount.

In an implementation, the user might still be able to purchase the item at the promotional price if the user makes the purchase within a certain time period (e.g., 24 hours) after a first associated user makes the purchase.

In one implementation where user purchases are private, the promotional price could be contingent on the user syndicating a feed item that includes the purchase information. In another implementation where the purchase is considered private, a user might only be informed about an associated user having already purchased the item if the user has greater than a certain number of associated users (e.g., one hundred associated users), such that the user is not made aware of the specific associated user that purchased the item, except that it was one of the user's associated users.

In one implementation where social annotations are applied to an advertisement for the purchased item, the purchasing user (or the purchasing user's review) might be labeled as an “early adopter”.

In one implementation, when the price or discount of an item is requested, a unique user ID can be passed (e.g., with a data access token for security purposes), as well as an identifier for the item or service being purchased. A user ID for the user's online social network can also be received, such that the user's social relationship data can be determined. The social relationship data could include either or both of the user's current edges and all of the edges that have existed during a promotional period. The system could then count the total number of associated users that have purchased the item, and record the timestamps of when each purchased occurs. The system could then identify the earliest (or latest) time at which one of the associated users purchased the item. The system can then compare the current time and the purchase time identified previously against any time-based filters or rules that might apply to the purchase. The system can then translate the number of purchasing associated users (e.g., either by function or lookup table) to identify a promotional price. The system can then return the promotional price, and, optionally, a promotional period that the promotional price is valid. In one implementation, the promotional period could last slightly longer than a displayed promotional time indicates, such that the user can complete the purchase.

In an implementation, users could pay for the items with virtual currency, e.g., for social game situations. In an implementation, the user could get a variable discount based on the number of associated users that purchased the item. For example, if the user is the first of the associated users to purchase the item, the user gets a 50% discount. If the user is the second of the associated users to purchase the item, the user guest a 40% discount, and so on. In one example, a discount timer could be reset every time an associated user purchases the item.

In an implementation, associated users of an associated user (e.g., “friends” of “friends”) could receive the promotional price. In one example, associated users of an associated user could receive a lesser discount.

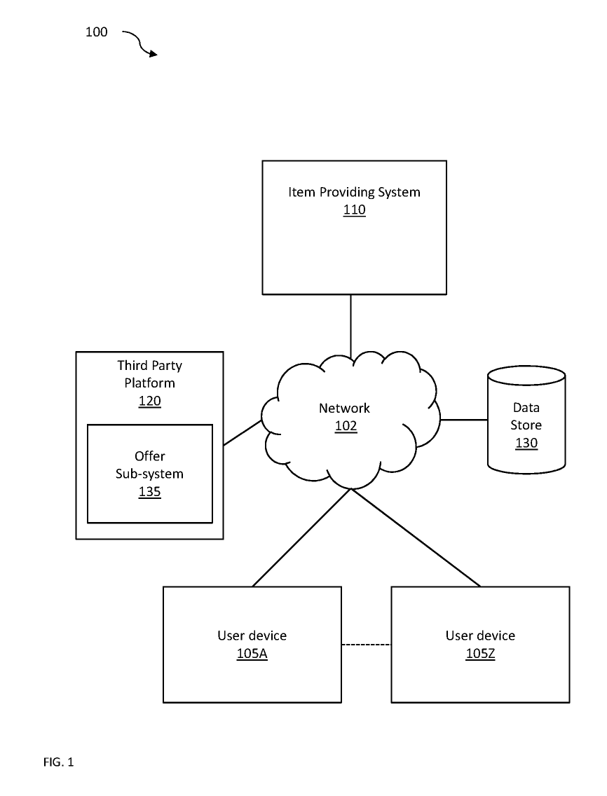

FIG. 1 illustrates exemplary system architecture 100, in accordance with one embodiment of the present disclosure. System 100 includes user devices 105A through 105Z in communication with (e.g., coupled to) an item providing system 110 and one or more third party platforms 120 over a network 102, and a data store 130. The network 102 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The user devices 105A through 105Z may be any type of computing device, for example, a device including a processor, a computer-readable medium, and a memory. In some embodiments, the user device 105A through Z may be executing a browser application or other application adapted to communicate over Internet related protocols (e.g., TCP/IP and HTTP) and/or display a user interface. System 100 may support a large number of concurrent sessions with many user devices.

The item providing system 110 and the third party platforms 120 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the disclosure may operate within a single server device or on multiple server devices.

In one embodiment, the item providing server 110 provides content including media items (e.g., digital video, streaming video, images, digital music, streaming music, social media information, digital images, photographs, etc.) to one or more of the client/user devices 105. For example, the item providing server 110 may be part of a content sharing platform and may provide a media item, such as a streaming video, requested by a user for playback on the user device 105 via the network 102. In other embodiments, the item providing server 110 provides applications (e.g., mobile applications, etc.), electronic books, computer games, subscription services, and/or physical items (e.g., books, toys, household goods, etc.).

In one embodiment, the third party platforms 120 provide an Internet-based method of sharing content. For example, the third party platforms 120 can be a social network, an image sharing platform, a video sharing platform, etc. A user can share content with desired viewers via the third party platforms 120. For example, the third party platform 120 may be one or more computing devices (e.g., servers), data stores, networks, software components, and/or hardware components that may be used to allow users to connect to, share information, and/or interact with each other. The third party platform 120 can be, for example, a social network (SN) that may present to a user a listing (e.g., activity feed, feed, stream, wall, etc.) of objects (such as posts, content items (e.g., video, images, audio, etc.), status updates, favorability indications, tags, messages, and so on) generated by other users of the social network. The third party platform 120 may also include a content sharing aspect that allows users to upload, view, tag, and share content, such as text content, video content, image content, audio content, and so on. Other users of the third party platform 120 may comment on the shared content, discover new content, locate updates, share content, and otherwise interact with the provided content.

In one implementation, the third party platform 120 can be a mobile platform to allow users to connect to, share information, and/or interact with each other using one or more mobile devices, smart phones, tablet devices, and other mobile communication devices that allow users to communicate over a telecommunications network. For example, the mobile platform may enable telephony communication, Short Message Service (SMS) messaging, Multimedia Message Service (MMS) messaging, text chat, and video chat between users.

Data store 130 can include one or more writable persistent storage devices, such as memories, tapes or disks. Although each of item providing system 110, third party platforms 120, and data store 130 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

During operation of system 100, an offer sub-system 135 of the third party platform 302 can identify social relationship data (e.g., a social graph) for a user. A social graph can include users (e.g., designated as nodes) and relationships between the users (e.g., designated as edges). Edges can be outgoing, incoming, or two-way (i.e., both out-going and incoming, such that both users are following each other). An outgoing edge can result by a user following another user. An incoming edge could result from the user being followed by another user. The social relationship data can include outgoing, incoming, and/or two-way edges, and can be recorded, e.g., in the data store 130, at the third party platform 302, or any other suitable location.

The offer sub-system 135 can provide an offer to the user on a user device 105A-Z to purchase an item at a promotional price (e.g., content, such as video or audio content, an electronic book, a computer game, an application, such as a mobile application, a physical item, etc.). The offer can be provided via email, text message, a post on the third party platform 105, a message through the third party platform, or any other suitable method.

The promotional price can be a discounted price from a list, retail, or usual price. The offer for the promotional price can be contingent on a timing condition, such as the user accepting the offer prior to any of the associated users identified in the social relationship data, within a certain time period, or within a certain time after an associated user purchases the item.

The offer sub-system 135 can identify the promotional price based on data provided by the item providing system 110. The item providing system 110 can indicate that the promotional price is based on, at least in part, information provided by the third party platform 105, such as the social relationship data. The promotional price can be identified based on other information, such as the number and/or type of “friends” of the user, how quickly the item is selling, past purchases of the item, the number of posts referencing the item, or any other suitable information.

The user can accept the offer, e.g., via the user device 105A-Z, and the offer sub-system 135 can determine whether the acceptance of the offer by the user satisfied the timing condition. For example, the offer sub-system 135 can determine if the user accepted the offer prior to any of the associated users purchasing the item and/or within an offer or promotional time period.

If the offer sub-system 135 determines that the acceptance of the user satisfied the timing condition, then the offer sub-system 135 can provide an indication, e.g., to the item providing system 110, that the user is allowed to purchase the item for the promotional price. In an implementation, the offer sub-system 135 can indicate that a code should be provided to the user for the user to share with associated users, such that the associated users can use the code to purchase the item at a discounted price, e.g., for a certain time period. For example, the user can provide the code to associated users via text, email, post, or any other suitable method.

In an implementation, the user can then provide a social annotation, e.g., on the user's account on the third party platform 105 or an a website of the item providing system 110, regarding the item. For example, the user can endorse the item. According to an implementation, the user must first provide a social annotation regarding the item before an indication is provided that the user can purchase the item for the promotional price.

In an implementation, when the user is the first of the associated users to purchase the item, the user can be labeled as an early adopter of the item on the third party platform 105 and/or the item providing system 110. For example, if an associated user views a page on the third party regarding the item, then there may be a posting on that page that the user has already purchased that item. In another example, if an associated user views a page on the item providing system 110 regarding the item, then there may be a posting on that page that the user has already purchased that item.

In other implementations, the offer sub-system can be located on the item providing system 110, where the item providing system 110 could receive the social relationship data from one or more third party platforms, or the item providing system 110 could include an online social network from which the social relationship data could be obtained. In other implementations, the offer sub-system 135 could be an independent system from the third party platform 105 and the item providing system.

In situations in which the systems discussed herein collect personal information about users, or may make use of personal information, the users may be provided with an opportunity to control whether the systems collect user information (e.g., information about a user's social network, social actions or activities, profession, a user's preferences, or a user's current location), or to control whether and/or how to receive content from the systems that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the systems.

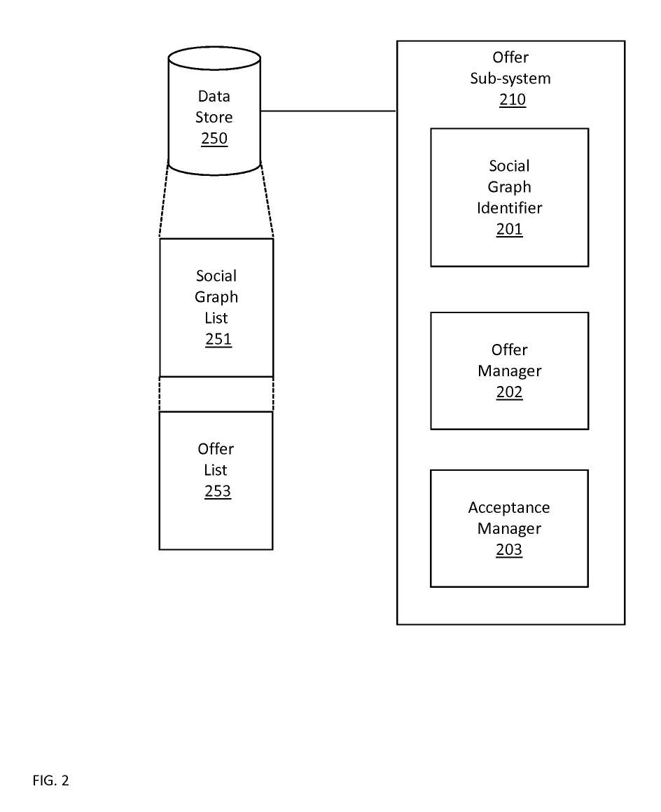

FIG. 2 illustrates an offer sub-system 210, in accordance with one embodiment of the present disclosure. The offer sub-system 210 may include a social graph identifier 201, an offer manager 202, and an acceptance manager 203. More or less components may be included in the content sharing system 210 without loss of generality. In an embodiment, offer sub-system 210 is offer sub-system 135 and data store 250 is data store 130 shown in FIG. 1.

In an implementation, the social graph identifier 201 identifies social relationship data for a user on an online social network. For example, the social graph identifier 201 can identify all users on the online social network that are associated with the user.

Once the social graph identifier 201 identifies the social relationship data, the social relationship data can be stored in a social graph list 251 in the data store 250. In an implementation the social graph identifier 201 can send the social relationship data to an item providing system for use by the item providing system to determine a promotional price and/or a timing condition.

Offer manager 202 can provide an offer to the user to purchase an item at a promotional price if an acceptance of the offer satisfies a timing condition. For example, the offer manager 202 can obtain information about the offer from the item providing system, such as a promotional price and a timing condition, (e.g., whether the acceptance must be received within a time period or prior to an associated user's purchase of the item). The offer manager 202 can also receive a time at which the offer should be given. In an implementation, the offer manager 202 can provide the offer to the user via a post on the online social network, via email, or in response to a request by the user or another system. In an implementation, the offer can be stored in an offer list 253 in the data store 250.

Acceptance manager 203 can receive can acceptance of the offer from the user. The acceptance manager 203 can then determine whether the acceptance of the offer satisfied the timing condition. For example, the acceptance manage 203 can determine whether the acceptance was received prior to a purchase of the item by an associated user or prior to the expiration of a promotional time period. In an implementation, the acceptance can be received via text, email, telephone, an indication through a retail website, selecting an element (e.g., a button) on a page on the online social network, or any other suitable method.

If the acceptance manager 203 determines that the acceptance of the offer did satisfy the timing condition, then the acceptance manager 203 can provide an indication that the user is allowed to purchase the item for the promotional price. For example, the indication can be provided to the item providing system.

In an implementation, the acceptance manger 203 can also provide a code (or provide an indication that a code should be provided) for the user to share with associated users where the code can be used by the associated users to purchase the item for a discounted price.

In an implementation, the acceptance manager 203 can also receive (or indicate that the user can submit) a social annotation (e.g., a review or an endorsement) about the product. For example, the acceptance manager 203 can then cause the social endorsement to be emailed, posted, or otherwise provide the social annotation to the associated users.

In an implementation where the offer is also contingent upon the user first providing a social annotation about the item, the acceptance manager 203 can first determine that the user has provided a social annotation regarding the item before providing an indication that the user is allowed to purchase the item for the promotional price.

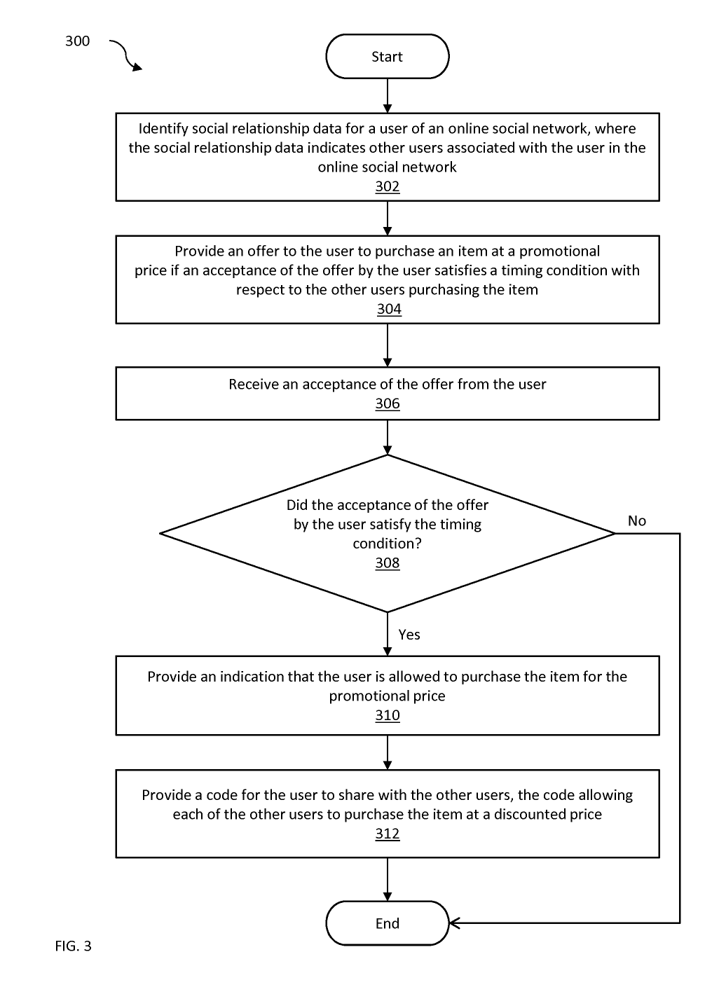

FIG. 3 is a flow diagram illustrating an embodiment for a method 300 of incentivizing a user to make a purchase. The method 300 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 300 is performed by an offer system (e.g., the offer sub-system 135 of FIG. 1).

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 302, processing logic identifies social relationship data for a user of an online social network, where the social relationship data indicates other users associated with the user in the online social network. For example, a social graph for User A can be determined on Social Network 1, where all of User A's 200 “friends” are recorded.

At block 304, processing logic provides an offer to the user to purchase an item at a promotional price if an acceptance of the offer by the user satisfies a timing condition with respect to the other users purchasing the item. Further to the example above, User A receives an email that offers a new e-book, Book Z, at a promotional price of $1 from Retailer R, if User A purchases Book Z before any of User A's 200 “friends” purchase book Z. User A can select Button B in the email to accept the offer.

At block 306, processing logic receives an acceptance of the offer from the user. Further to the example above, User A selects Button B to accept the offer.

At block 308, processing logic determines whether the acceptance of the offer by the user satisfied the timing condition. The timing condition may require that the user accept the offer prior to (or within a certain time interval from) other users related the user. Further to the example above, User A has selected Button B, and therefore accepted the offer, prior to any of User A's 200 “friends”.

At block 310, processing logic provides an indication that the user is allowed to purchase the item for the promotional price. Further to the example above, Retailer R is notified that User A has accepted the offer prior to any of User A's 200 “friends” and should thus be allowed to purchase Book Z for $1. User A can then enter any other information, such as payment and shipping information, needed to complete the purchase of Book Z.

At block 312, optionally, processing logic provides a code for the user to share with the other users, where the code allows each of the other users to purchase the item at a discount price. Further to the example above, after purchasing Book Z, User A can receive a code that User A can post on User A's online social network page such that any of the 200 “friends” of User A can see the code and use the code to purchase Book Z at a discount price. User A could also syndicate a feed item with the code to User A's “friends” that are following User A. In another example, User A can enter the email addresses of “friends” that might be interested in purchasing Book Z and an offer to purchase Book Z can be sent to the “friends”, or User A can email the code to User A's “friends”.

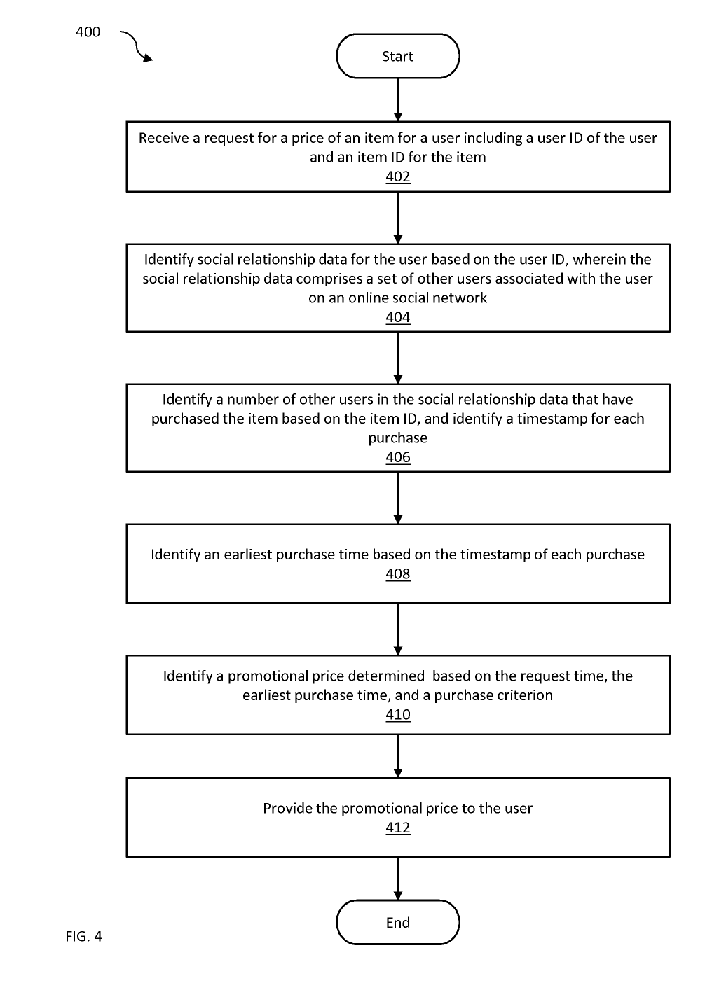

FIG. 4 is a flow diagram illustrating an embodiment for a method 400 of incentivizing a user to make a purchase. The method 400 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 400 is performed by an offer system (e.g., the offer sub-system 135 of FIG. 1).

At block 402, processing logic receives a request for a price of an item for a user including a user ID of the user and an item ID for the item. In an example, a price for a video, Movie A, can be requested for User A. In implementations, the request can be from a user, an item providing system, or another system.

At block 404, processing logic identifies social relationship data for the user based on the user ID, where the social relationship data includes a set of other users associated with the user on an online social network. The request can be received from an item providing system or from the user. Further to the example above, User A's “friends” on an online social network are determined.

At block 406, processing logic identifies a number of other users in the social relationship data that purchased the item based on the item ID, and identifies a timestamp for each purchase. Further to the example above, each of User A's “friends” that have purchased Movie A, if any, are determined, and the times of the purchases, if any, can be determined.

At block 408, processing logic identifies an earliest purchase time based on the timestamp of each purchase. Further to the example above, the earliest time of any of the purchases of Movie A by User A's “friends”, if any, is determined.

At block 410, processing logic identifies a promotional price determined based on the request time, the earliest purchase time, and a purchase criterion. Further to the example above, the purchase criterion can be that User A will receive a discounted price if User A is the first to purchase Movie from among User A's friends. Here, a price for User A for Movie A is be $10, rather than the regular price of $15, because the price was requested prior to a purchase of Movie A by any of User A's “friends”.

At block 412, processing logic provides the promotional price to the user. Further to the example above, User A receives notification that the price for Movie A is $10.

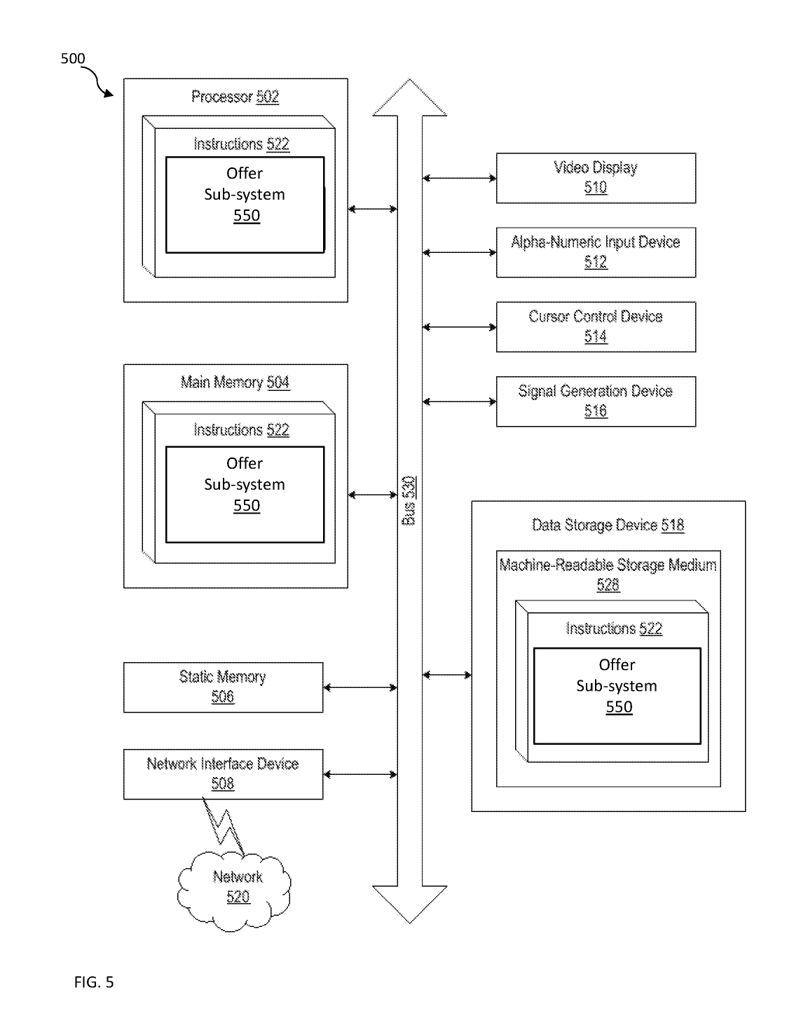

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 526 for performing the operations and steps discussed herein.

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a computer-readable storage medium 528 (or machine-readable storage medium) on which is stored one or more sets of instructions 522 (e.g., software) embodying any one or more of the methodologies or functions described herein. The instructions 522 may also reside, completely or at least partially, within the main memory 504 and/or within the processor 502 during execution thereof by the computer system 500, the main memory 504 and the processor 502 also constituting computer-readable storage media. The instructions 522 may further be transmitted or received over a network 520 via the network interface device 508.

In one embodiment, the instructions 526 include instructions for a offer sub-system 550, which may correspond to offer sub-system 135 of FIG. 1, and/or a system for providing an offer to a user. While the computer-readable storage medium 528 (or machine-readable storage medium) is shown in an exemplary embodiment to be a single medium, the term “computer-readable storage medium” (or “machine-readable storage medium”) should be taken to include a single medium or multiple media (e.g., a centralized or distributed database, and/or associated caches and servers) that store the one or more sets of instructions. The term “computer-readable storage medium” (or “machine-readable storage medium”) shall also be taken to include any medium that is capable of storing, encoding or carrying a set of instructions for execution by the machine and that cause the machine to perform any one or more of the methodologies of the present disclosure. The term “computer-readable storage medium” (or “machine-readable storage medium”) shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method comprising:
identifying, by a processing device, social relationship data for a user of an online social network, the social relationship data indicating a total number of other users connected with the user in the online social network;
determining a promotional price in view of the total number of the other users connected with the user in the online social network, wherein the promotional price is inversely related to the total number of the other users connected with the user;
providing, by the processing device, an offer to the user to purchase an item at the promotional price;
determining, by the processing device, whether an acceptance of the offer by the user satisfies a timing condition with respect to other users purchasing the item; and
in response to determining the acceptance satisfies the timing condition, providing, by the processing device, an indication that the user is allowed to purchase the item for the promotional price.

2. The method of claim 1, further comprising:
providing a code for the user to share with the other users, the code allowing each of the other users to purchase the item at a discounted price.

3. The method of claim 2, wherein the code is only valid for a time period.

4. (canceled)

5. The method of claim 1, wherein the offer is valid for a promotional period, and wherein the indication that the user is allowed to purchase the item for the promotional price is further in response to determining that the user accepted the offer within the promotional period.

6. The method of claim 1 further comprising allowing any of the other users to purchase the item at the promotional price for a period after the user accepts the offer.

7. The method of claim 1, wherein providing the indication that the user is allowed to purchase the item for the promotional price comprises determining that the user has notified the other users that the user has accepted the offer.

8. The method of claim 1, wherein the timing condition is satisfied if the user accepts the offer prior to any of the other users connected with the user.

9. The method of claim 1, wherein the timing condition is satisfied if the user accepts the offer within a predefined time period from a purchase of the item by one of the other users connected with the user in the online social network.

10. A method comprising:
receiving a request for a price of an item for a user, the request comprising a user ID of the user and an item ID for the item;
identifying a social relationship data for the user based on the user ID, wherein the social relationship data comprises a total number of other users connected with the user on an online social network;
identifying other users in the social relationship data that have purchased the item based on the item ID;
identifying an earliest purchase time based on a timestamp of each purchase;
identifying a promotional price determined based on a time of the request, the earliest purchase time, and the total number of the other users connected with the user, wherein the promotional price is inversely related to the total number of the users connected with the user;
providing the promotional price to the user; and
wherein the method is performed by one or more processing devices.

11. The method of claim 10 further comprising:
identifying a purchase period calculated based on the time of the request, the earliest purchase time, and the purchase criterion; and
providing the purchase period to the user.

12. A non-transitory computer readable storage medium having instructions that, when executed by a processing device, cause the processing device to perform operations comprising:
identifying social relationship data for a user of an online social network, the social relationship data indicating a total number of other users connected with the user in the online social network;
determining a promotional price in view of the total number of the other users connected with the user in the online social network, wherein the promotional price is inversely related to the total number of the other users connected with the user;
providing an offer to the user to purchase an item at the promotional price;
determining whether an acceptance of the offer by the user satisfies a timing condition with respect to other users purchasing the item; and
in response to determining the acceptance satisfies the timing condition, providing an indication that the user is allowed to purchase the item for the promotional price.

13. The non-transitory computer readable storage medium of claim 12, wherein the operations further comprise:
providing a code for the user to share with the other users, the code allowing each of the other users to purchase the item at a discounted price.

14. The non-transitory computer readable storage medium of claim 13, wherein the code is only valid for a time period.

15. (canceled)

16. The non-transitory computer readable storage medium of claim 12, wherein the offer is valid for a promotional period, and wherein the indication that the user is allowed to purchase the item for the promotional price is further in response to determining that the user accepted the offer within the promotional period.

17. The non-transitory computer readable storage medium of claim 12, wherein the operations further comprise allowing any of the other users to purchase the item at the promotional price for a period after the user accepts the offer.

18. The non-transitory computer readable storage medium of claim 12, wherein providing the indication that the user is allowed to purchase the item for the promotional price comprises determining that the user has notified the other users that the user has accepted the offer.

19. The non-transitory computer readable storage medium of claim 12, wherein the timing condition is satisfied if the user accepts the offer prior to any other user connected with the user in the online social network.

20. The non-transitory computer readable storage medium of claim 12, wherein the timing condition is satisfied if the user accepts the offer within a predefined time period from a purchase of the item by one of the other users connected with the user in the online social network.

21. A computing device comprising:
a memory; and
a processing device coupled to the memory, wherein the processing device is to:
identify social relationship data for a user of an online social network, the social relationship data indicating a total number of other users connected with the user in the online social network;
determine a promotional price in view of the total number of the other users connected with the user in the online social network, wherein the promotional price is inversely related to the total number of the other users;
provide an offer to the user to purchase an item at the promotional price;
determine whether an acceptance of the offer by the user satisfies a timing condition with respect to other users purchasing the item; and
in response to determining the acceptance satisfies the timing condition, provide an indication that the user is allowed to purchase the item for the promotional price.

22. The computing device of claim 21, wherein the processing device is further to provide a code for the user to share with the other users, the code allowing each of the other users to purchase the item at a discounted price.

23. The computing device of claim 22, wherein the code is only valid for a time period.

24. (canceled)

25. The computing device of claim 21, wherein the offer is valid for a promotional period, and wherein the indication that the user is allowed to purchase the item for the promotional price is further in response to determining that the user accepted the offer within the promotional period.

26. The computing device of claim 21, wherein the processing device is further to allow any of the other users to purchase the item at the promotional price for a period after the user accepts the offer.

27. The computing device of claim 21, wherein to provide the indication that the user is allowed to purchase the item for the promotional price, the processing device is to determine that the user has notified the other users that the user has accepted the offer.

28. The computing device of claim 21, wherein the timing condition is satisfied if the user accepts the offer prior to any other user connected with the user in the online social network.

29. The computing device of claim 21, wherein the timing condition is satisfied if the user accepts the offer within a predefined time period from a purchase of the item by one of the other users connected with the user in the online social network.

30. The method of claim 1, wherein determining the promotional price comprises determining the promotional price prior to receiving an acceptance of the offer from any of the other users connected with the user.

31. The method of claim 1, wherein determining whether the acceptance of the offer satisfies the time condition comprises:
identifying users that accepted the offer;
comparing the users that accepted the offer with the users connected with the user of the social network;
enabling the user of the social network to accept the offer in response to the users that accepted the offer not matching the users connected with the user; and
disabling the user from accepting the offer in response to at least one of the users that accepted the offer matching one of the users connected with the user.
